(19) United States
(12) Patent Application Publication
(10) Pub. No.: US 2014/0001660 A1
(43) Pub. Date: Jan. 2, 2014

(54) OPTICAL COMPONENT MANUFACTURING METHOD AND OPTICAL COMPONENT MANUFACTURING APPARATUS

(71) Applicant: FUJITSU LIMITED, Kawasaki-shi (JP)

(72) Inventors: Toru OKADA, Yokohama (JP); Satoshi EMOTO, Nagano (JP)

(21) Appl. No.: 13/912,672

(22) Filed: Jun. 7, 2013

(30) Foreign Application Priority Data
Jun. 27, 2012 (JP) 2012-143631

(51) Int. Cl. B29D 11/00

(52) U.S. Cl. CPC B29D 11/00692
USPC 264/1.24; 425/150

(57) ABSTRACT

A method for manufacturing an optical component, the method includes taking an image of an end face of an optical waveguide component including a core and a cladding, aligning a position of the core with a position of a mold, on a basis of the position of the core within the taken image, and forming a lens on a surface of an optical film positioned at the end face of the optical waveguide component by pressing the mold onto the optical film.

### CROSS-REFERENCE TO RELATED APPLICATION

This application is based upon and claims the benefit of priority of the prior Japanese Patent Application No. 2012-143631, filed on Jun. 27, 2012, the entire contents of which are incorporated herein by reference.

### FIELD

The embodiment discussed herein is related to an optical component manufacturing method and an optical component manufacturing apparatus.

### BACKGROUND

In related art, compact and inexpensive butt jointing is often used to provide optical coupling between optical waveguide components having an optical waveguide including a core and a cladding.

There are also cases where a lens is interposed between one optical waveguide component and the other optical waveguide component, and the optical waveguide components are optically coupled via the lens.

Further, there are also techniques that form an oxide film having a lens function on the end face of the core of an optical fiber or optical waveguide by blowing oxide material gas while applying laser light (see, for example, Japanese Laid-open Patent Publication No. 05-164931).

As related art, there are Japanese Laid-open Patent Publication No. 2002-258089, Japanese Laid-open Patent Publication No. 2011-222705, and Japanese Laid-open Patent Publication No. 2007-121356.

However, in the case of using butt jointing mentioned above, high positioning accuracy is to be attained to achieve high optical coupling efficiency. That is, for the positioning between one optical waveguide component and the other optical waveguide component, very little error is tolerated, and high positioning accuracy is to be attained.

In the case of interposing a lens between optical waveguide components mentioned above, lens attitude control, a lens holding mechanism, or the like is to be provided. Therefore, the positioning between one optical waveguide component, the lens, and the other optical waveguide component is not easy, and it is difficult to achieve optical coupling between the optical waveguide components in a compact and inexpensive manner.

Further, with the technique of forming an oxide film having a lens function mentioned above, it is difficult to form the lens with good accuracy with respect to the position of the core in an easy and inexpensive manner.

Accordingly, it is desired to enable the lens to be formed with good accuracy with respect to the position of the core of the optical waveguide component in an easy and inexpensive manner.

### SUMMARY

According to an aspect of the embodiments, an apparatus includes taking an image of an end face of an optical waveguide component including a core and a cladding, aligning a position of the core with a position of a mold, on a basis of the position of the core within the taken image, and forming a lens on a surface of an optical film positioned at the end face of the optical waveguide component by pressing the mold onto the optical film

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a schematic perspective view for explaining an optical component manufacturing method and an optical component manufacturing apparatus according to the embodiment;

FIGS. 2A and 2B are schematic drawings of the shape of the tip portion of an imprint tip tool used in the optical component manufacturing method and the optical component manufacturing apparatus according to the embodiment, of which FIG. 2A is a perspective view, and FIG. 2B is a cross-sectional view;

FIG. 3 is a schematic perspective view for explaining the optical component manufacturing method according to the embodiment;

FIG. 4 is a schematic perspective view for explaining the optical component manufacturing method according to the embodiment;

FIGS. 5A to 5C are schematic cross-sectional views for explaining the optical component manufacturing method according to the embodiment;

FIG. 6 is a schematic perspective view for explaining the optical component manufacturing method and the optical component manufacturing apparatus according to the embodiment;

FIG. 7 is a schematic perspective view for explaining the optical component manufacturing method and the optical component manufacturing apparatus according to the embodiment;

FIG. 8 is a schematic cross-sectional view depicting the configuration of an optical component manufactured by the optical component manufacturing method and the optical component manufacturing apparatus according to the embodiment;

FIG. 9 is a schematic cross-sectional view depicting the optical component manufactured by the optical component manufacturing method and the optical component manufacturing apparatus according to the embodiment, that is, a structure in which an optical waveguide component with a lens serving as an incidence-side component, and an emission-side component are optically coupled via the lens;

FIGS. 10A and 10B are diagrams depicting the relationship between offset value and optical coupling efficiency in the optical coupling structure depicted in FIG. 9, of which FIG. 10A depicts a case where the offset is in the X-direction and FIG. 10B depicts a case where the offset is in the Y-direction;

FIG. 11 is a schematic perspective view depicting a structure in which an incidence-side component and an emission-side component are optically coupled by butt jointing;

FIG. 12 is a schematic cross-sectional view depicting the configuration of an optical component including a double lens structure as a modification of the optical component manufactured by the optical component manufacturing method and the optical component manufacturing apparatus according to the embodiment; and

FIG. 13 is a schematic perspective view depicting the configuration of an optical component including multiple lenses as a modification of the optical component manufactured by the optical component manufacturing method and the optical component manufacturing apparatus according to the embodiment.

### DESCRIPTION OF EMBODIMENT

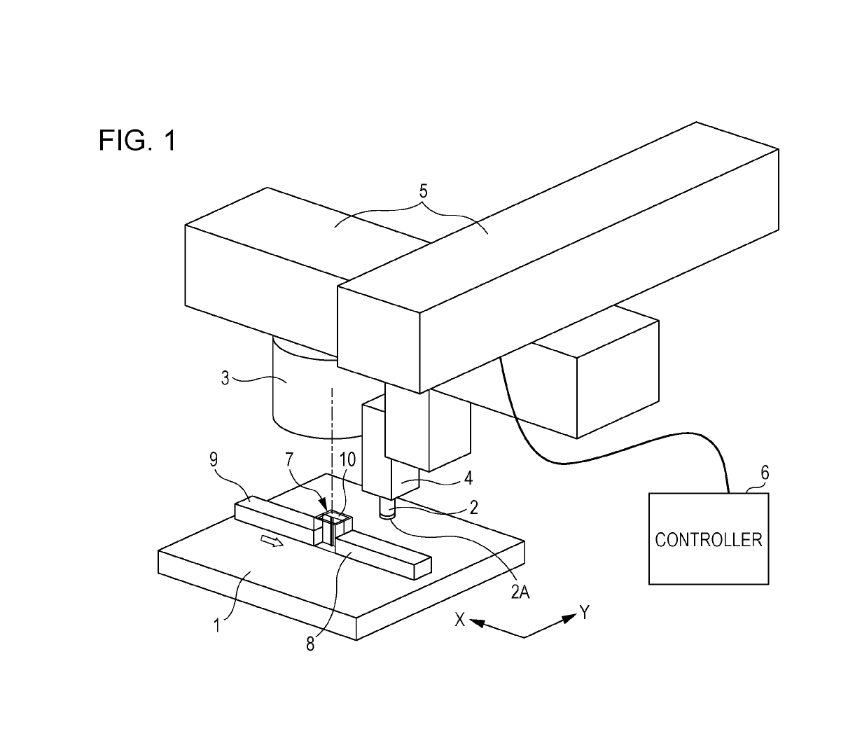

Hereinafter, an optical component manufacturing method and an optical component manufacturing apparatus according to the embodiment are described with reference to FIGS. 1 to 11.

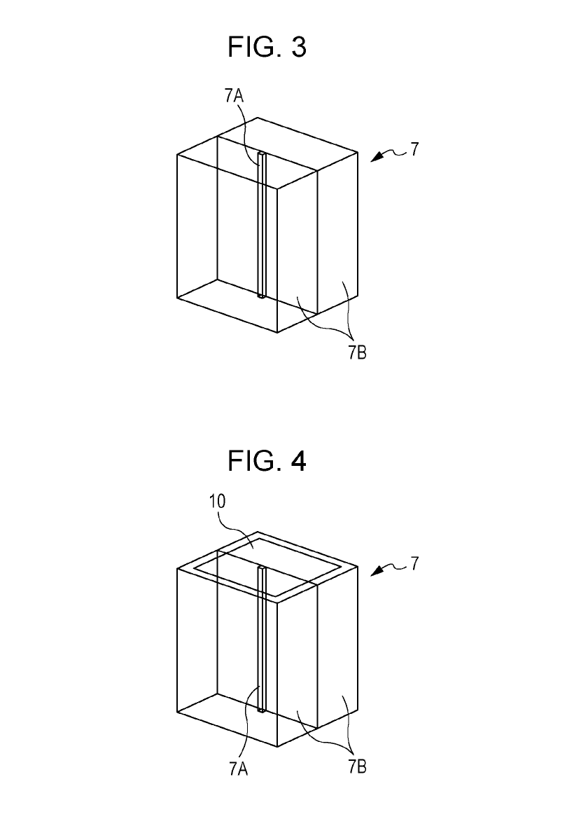

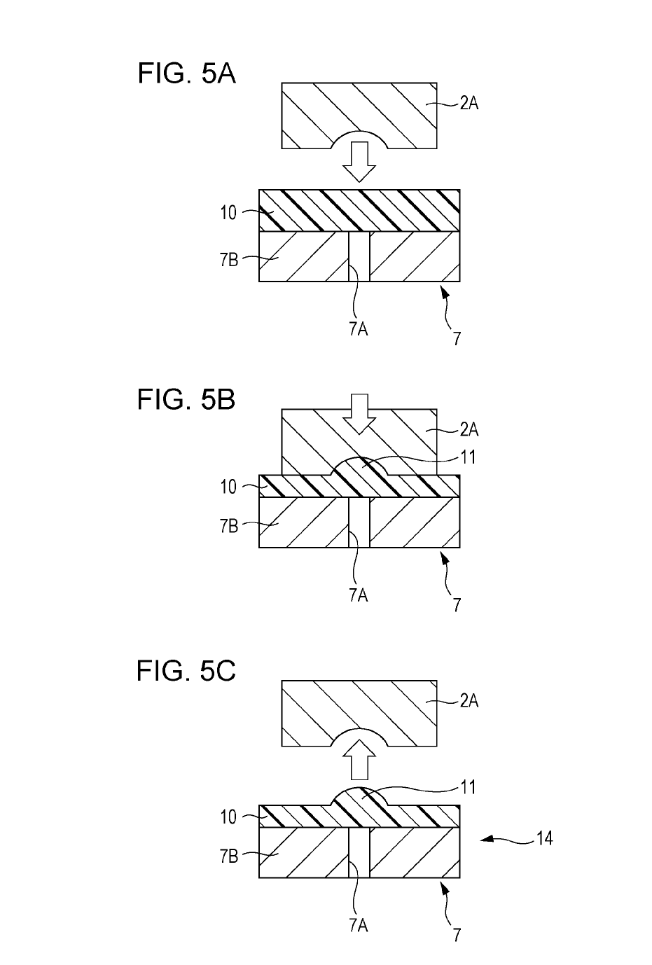

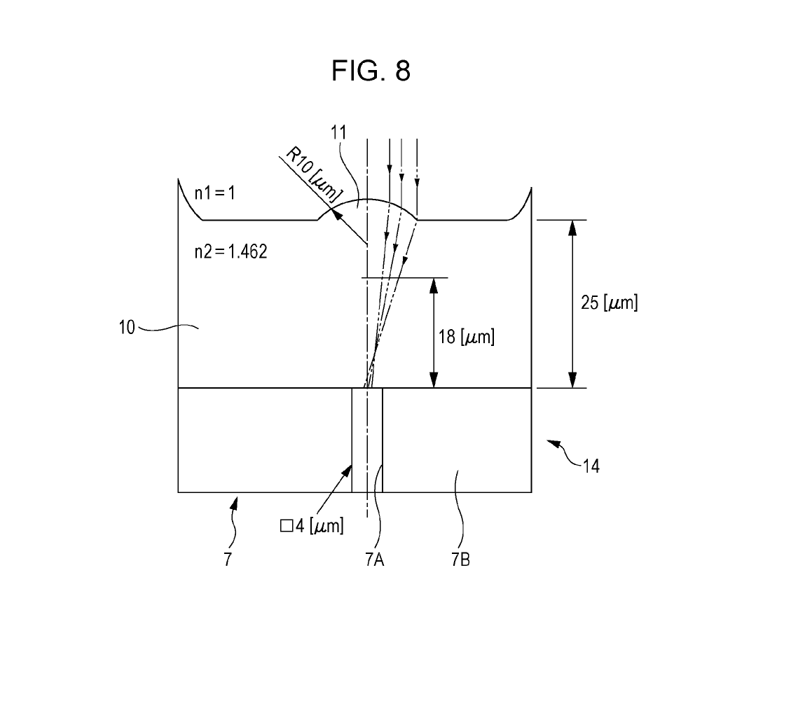

The optical component manufacturing apparatus according to the embodiment is an apparatus that manufactures an optical component 14 (see, for example, FIG. 5C and FIG. 8) with a lens 11 mounted on the end face of an optical waveguide component 7 (see, for example, FIG. 3). The optical waveguide component 7 has an optical waveguide including a core 7A and a cladding 7B. The optical waveguide is also referred to as light guide.

The optical waveguide component 7 is an optical component that has one or multiple optical waveguides (including one or multiple optical fibers). For example, the optical waveguide component 7 is an optical connector having a laser diode (LD), a second harmonic generator (SHG), and multiple optical waveguides or multiple optical fibers. The laser diode is also referred to as emission-side optical waveguide component, emission-side optical component, or emission-side component. The second harmonic generator is also referred to as incidence-side optical waveguide component, incidence-side optical component, or incidence-side component.

In this embodiment, as described later, a mold 2A is pressed onto an optical film 10 positioned at the end face of the optical waveguide component 7 to form the lens 11 on the surface of the optical film 10, thereby manufacturing the optical component 14 with the lens 11 mounted on the end face of the optical waveguide component 7. Accordingly, the optical component manufacturing apparatus is an imprint apparatus that presses the mold 2A onto the optical film 10 positioned at the end face of the optical waveguide component 7, and transfers a lens shape formed in the mold 2A onto the optical film 10 to thereby form the lens 11 on the surface of the optical film 10. The optical film 10 is also referred to as a lens substrate. The end face of the optical waveguide component 7, that is, the end face of the optical waveguide is also referred to as the aperture face of the optical waveguide.

As depicted in FIG. 1, the imprint apparatus according to the embodiment includes a table 1, an imprint tip tool 2, a camera 3, an elevator 4, an X-Y mover 5, and a controller 6.

The table 1 is a table on which to place the optical waveguide component 7. The table 1 includes an abutment part 8 and a chuck 9 that are located across a component placement region at the center of the table 1. The chuck 9 is capable of moving toward and away from the abutment part 8. The optical waveguide component 7 may be fixed on the table 1 by holding the optical waveguide component 7 between the abutment part 8 and the chuck 9. While the fixing of the optical waveguide component 7 with the chuck 9 is performed with respect to the X-direction in the present case, this is not to be construed restrictively. The fixing may be performed with respect to the Y-direction, or may be performed with respect to the X-direction and the Y-direction.

The imprint tip tool 2 includes the mold 2A at its tip portion (see, for example, FIGS. 5A to 5C). The mold 2A is pressed onto the optical film 10 positioned at the end face of the optical waveguide component 7 to form the lens 11 on the surface of the optical film 10. The mold 2A is also referred to as imprint mold or master mold. In the present case, the imprint tip tool 2 and the mold 2A are formed integrally, and the tip portion of the imprint tip tool 2 serves as the mold 2A. However, this is not to be construed restrictively. For example, the mold 2A may be mounted on the tip portion of the imprint tip tool 2.

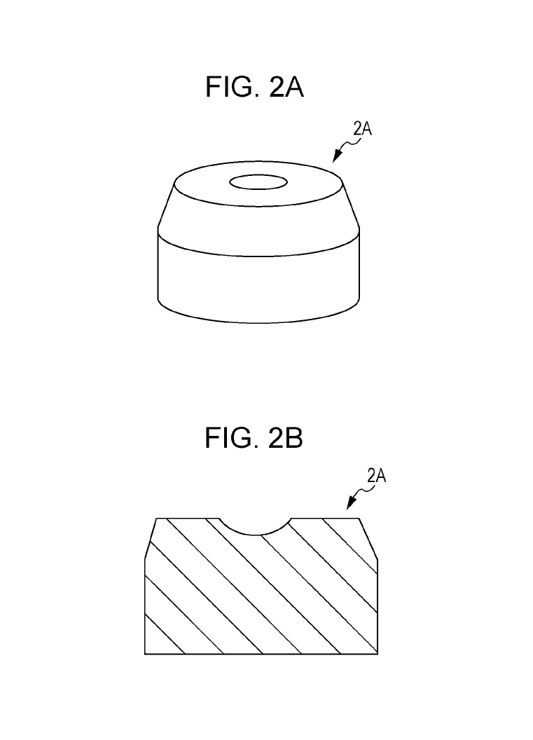

In the present case, as depicted in FIGS. 2A and 2B, the mold 2A provided at the tip portion of the imprint tip tool 2 is shaped so that the center portion of its end face is depressed in the shape of a concave lens. Therefore, as the mold 2A is pressed onto the optical film 10 and the concave lens shape is transferred to the optical film 10, the lens (convex lens) 11 is formed on the optical film 10 (see, for example, FIGS. 5A to 5C).

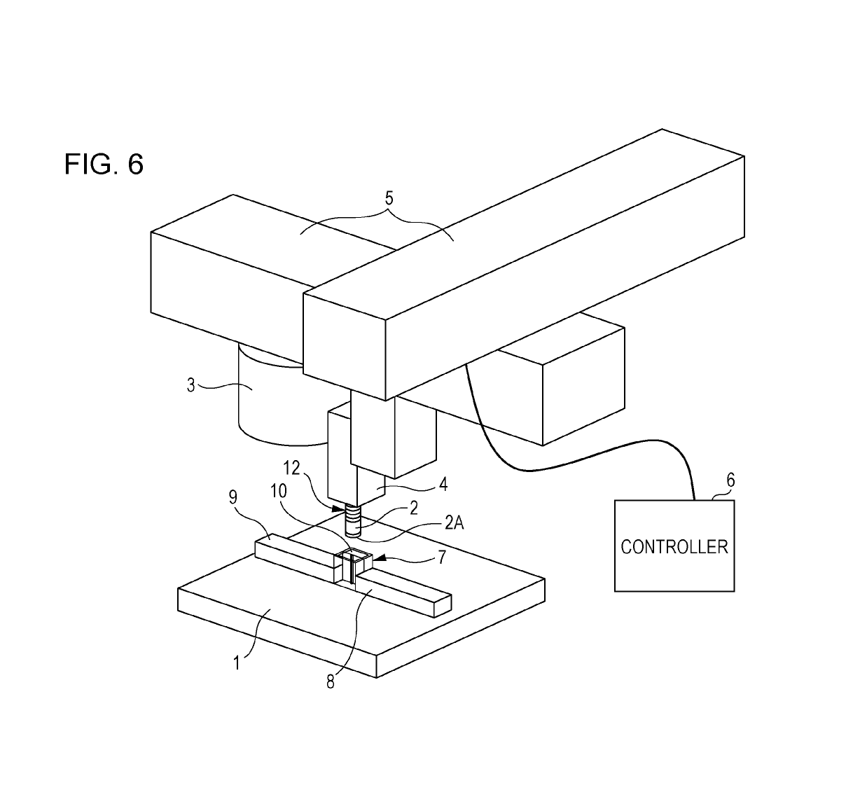

In a case where a thermosetting resin film is used as the optical film 10, for example, the imprint tip tool 2 may be made of a material capable of transferring heat such as metal (e.g. electroformed Ni) and, as depicted in FIG. 6, a heater 12 that heats the optical film (thermosetting resin film) 10 may be provided at the basal portion of the imprint tip tool 2. Then, with the mold 2A provided at the tip portion of the imprint tip tool 2 being pressed on the optical film (thermosetting resin film) 10, the optical film (thermosetting resin film) 10 may be heated by the heater 12 to thereby set the optical film (thermosetting resin film) 10. Moreover, operation of the heater 12 may be controlled by the controller 6.

In a case where a photosetting resin film is used as the optical film 10, for example, the imprint tip tool 2 may be made of a material that transmits light, and a light source (not depicted) that irradiates the optical film (photosetting resin film) 10 with light may be provided. Then, with the mold 2A provided at the tip portion of the imprint tip tool 2 being pressed on the optical film (photosetting resin film) 10, the optical film (photosetting resin film) 10 may be irradiated with light from the light source to thereby set the optical film (photosetting resin film) 10. In this case, the light source may be provided at a position that allows the light source to irradiate the optical film (photosetting resin film) 10 with light from above in a state where the mold 2A provided at the tip portion of the imprint tip tool 2 is pressed on the optical film (photosetting resin film) 10 positioned at the end face of the optical waveguide component 7. This light source may be moved by the X-Y mover 5 together with the imprint tip tool 2, may be raised and lowered by the elevator 4 together with the imprint tip tool 2, or may be fixed in position so as not to move. Moreover, operation of the light source may be controlled by the controller 6.

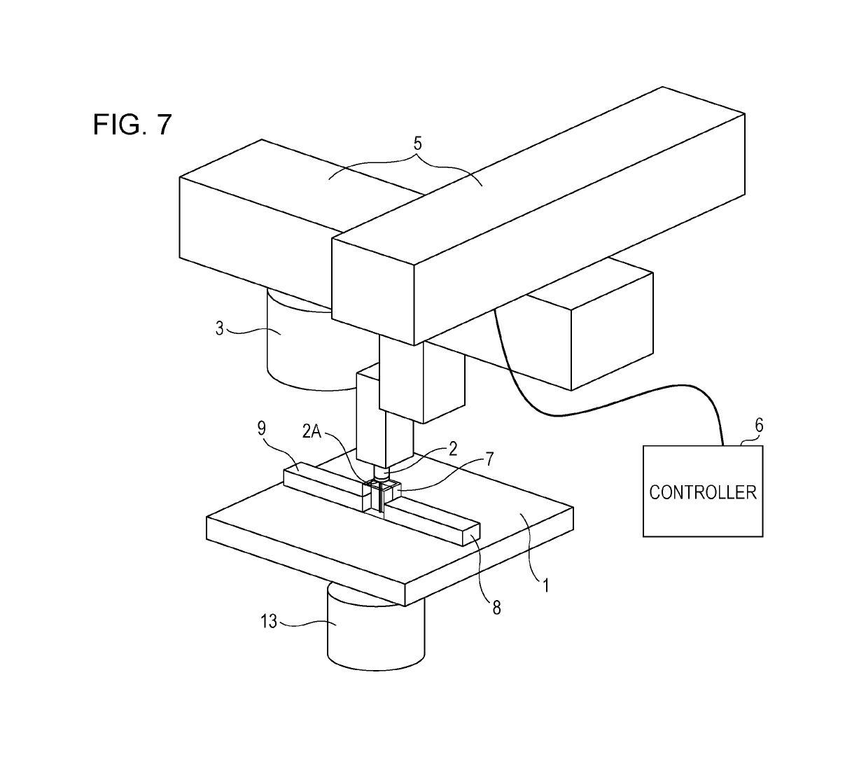

The position of the light source is not limited to the position mentioned above. For example, as depicted in FIG. 7, a light source 13 may be provided on the back side of the table 1. That is, the light source 13 may be provided on the side of the table 1 opposite to the side on which the optical waveguide component 7 is placed. In this case, the imprint tip tool 2 may not be made of a material that transmits light. It suffices that at least the component placement region of the table 1 be able to transmit light. With the mold 2A provided at the tip portion of the imprint tip tool 2 being pressed on the optical film (photosetting resin film) 10, the optical film (photosetting resin film) 10 may be irradiated with light through the core 7A of the optical waveguide component 7 from the light source 13 provided on the back side of the table 1, thereby setting the optical film 10 (see, for example, FIG. 7).

In a case where only a thermosetting resin film is used as the optical film 10, the light source may not be provided. Conversely, in a case where only a photosetting resin film is used as the optical film 10, the heater 12 may not be provided. In a case where both a thermosetting resin film and a photosetting resin film are used as the optical film 10, both the heater 12 and the light source may be provided.

The camera 3 takes an image of the end face of the optical waveguide component 7. In the present case, the camera 3 takes an image of the end face (the end face on the upper side in FIG. 4 in the present case) of the optical waveguide component 7 including the core 7A located at the center of the optical waveguide component 7. The camera 3 is connected to the controller 6. The image taken by the camera 3 is sent to the controller 6. The camera 3 is also referred to as imaging unit.

The elevator 4 and the X-Y mover 5 move the imprint tip tool 2, that is, the mold 2A with respect to the end face of the optical waveguide component 7. Accordingly, the imprint tip tool 2 provided with the mold 2A is mounted to the elevator 4 and the X-Y mover 5 as depicted in FIG. 1. That is, the imprint tip tool 2 provided with the mold 2A is mounted on the elevator 4. The elevator 4 on which the imprint tip tool 2 provided with the mold 2A is mounted is mounted on the X-Y mover 5. The elevator 4 and the X-Y mover 5 are also referred to as moving mechanism.

The elevator 4 moves the imprint tip tool 2, that is, the mold 2A up and down. That is, lowering the imprint tip tool 2 by the elevator 4 makes it possible to press the mold 2A provided at the tip of the imprint tip tool 2 onto the optical film 10 positioned at the end face of the optical waveguide component 7. Raising the imprint tip tool 2 provided with the mold 2A by the elevator 4 makes it possible to separate the mold 2A pressed on the optical film 10 from the optical film 10.

The X-Y mover 5 moves the elevator 4, on which the imprint tip tool 2 provided with the mold 2A is mounted, in the X-direction and the Y-direction. That is, when forming the lens 11, the elevator 4 is moved in the X-direction and the Y-direction by the X-Y mover 5, thereby positioning the imprint tip tool 2, that is, the mold 2A above the optical waveguide component 7. The X-Y mover 5 also moves the camera 3 in the X-direction and the Y-direction. When forming the lens 11, the camera 3 is also moved in the X-direction and the Y-direction together with the elevator 4, and retracted from the position above the optical waveguide component 7. When taking an image of the end face of the optical waveguide component 7 by the camera 3, the camera 3 is moved in the X-direction and the Y-direction by the X-Y mover 5 so that the camera 3 may be positioned above the optical waveguide component 7. At this time, the elevator 4 and the imprint tip tool 2 (i.e. mold 2A) mounted to the elevator 4 are also moved in the X-direction and the Y-direction, and retracted from the position above the optical waveguide component 7.

The controller 6 controls the elevator 4 and the X-Y mover 5. The controller 6 is, for example, a computer including a CPU, a memory, a storage, and the like.

In particular, in this embodiment, the controller 6 controls the X-Y mover 5 so that the center position of the core 7A and the center position of the mold 2A coincide with each other, on the basis of the center position of the core 7A within an image taken by the camera 3.

That is, the controller 6 captures the image taken by the camera 3, and determines the center position of the core 7A within the image through image processing. For example, the controller 6 determines the region of the core 7A on the basis of light and dark areas in the taken image, and further determines the position of the center of gravity of the region of the core 7A, thereby determining the center position of the core 7A. Then, the controller 6 calculates and stores the amount of misalignment (offset) of the center position of the core 7A with respect to the center position of the taken image. For example, the controller 6 calculates and stores the positional relationship between the X-coordinate and the Y-coordinate indicative of the center position of the taken image, and the X-coordinate and the Y-coordinate indicative of the center position of the core 7A, that is, the X-direction distance and the Y-direction distance between these two points. The center position of the taken image corresponds to the center position of the camera 3.

The controller 6 stores the amount of misalignment (offset) of the center position of the mold 2A with respect to the center position of the camera 3 in advance. For example, the controller 6 stores the positional relationship between the X-coordinate and the Y-coordinate indicative of the center position of the camera 3, and the X-coordinate and the Y-coordinate indicative of the center position of the mold 2A, that is, the X-direction distance and the Y-direction distance between these two points in advance. The center position of the mold 2A corresponds to the center position of the lens 11 formed by using the mold 2A. The center position of the mold 2A is also the center position of the imprint tip tool 2.

The controller 6 calculates and stores the amount of misalignment of the mold 2A with respect to the core 7A, on the basis of the amount of misalignment of the core 7A with respect to the center position of the taken image, and the amount of misalignment of the mold 2A with respect to the center position of the camera 3. For example, on the basis of the positional relationship between the X-coordinate and the Y-coordinate indicative of the center position of the taken image, and the X-coordinate and the Y-coordinate indicative of the center position of the core 7A, and the positional relationship between the X-coordinate and the Y-coordinate indicative of the center position of the camera 3, and the X-coordinate and the Y-coordinate indicative of the center position of the mold 2A, the controller 6 calculates and stores the positional relationship between the X-coordinate and the Y-coordinate indicative of the center position of the core 7A, and the X-coordinate and the Y-coordinate indicative of the center position of the mold 2A, that is, the X-direction distance and the Y-direction distance between these two points.

Then, the controller 6 controls the X-Y mover 5 on the basis of the amount of misalignment of the center position of the mold 2A with respect to the center position of the core 7A calculated as described above, for example, the positional relationship between the X-coordinate and the Y-coordinate indicative of the center position of the core 7A, and the X-coordinate and the Y-coordinate indicative of the center position of the mold 2A. For example, the controller 6 moves the X-Y mover 5 so that the X-coordinate and the Y-coordinate indicative of the center position of the core 7A, and the X-coordinate and the Y-coordinate indicative of the center position of the mold 2A coincide with each other (see, for example, FIG. 5A).

In this case, the optical axis of the core 7A (the optical axis of the optical waveguide) is located on the optical axis of the lens 11 formed by using the mold 2A (see, for example, FIG. 8). That is, in the optical component 14 including the optical film 10 having the lens 11 provided at the end face of the optical waveguide component 7, the optical axis of the core 7A provided in the optical waveguide component 7, and the optical axis of the lens 11 formed on the surface of the optical film 10 stuck on the end face of the optical waveguide component 7 coincide with each other.

In this embodiment, the position of the table 1 in the X-direction and the Y-direction is fixed, and the position of the imprint tip tool 2 (i.e. the mold 2A) is moved in the X-direction and the Y-direction by the X-Y mover 5. However, this is not to be construed restrictively. For example, the position of the imprint tip tool 2 in the X-direction and the Y-direction may be fixed, and the position of the table 1 may be moved in the X-direction and the Y-direction. In this case, instead of the X-Y mover 5 mentioned above, an X-Y mover that moves the table 1 in the X-direction and the Y-direction is provided. This X-Y mover and the above-mentioned elevator 4 constitute the moving mechanism that moves the imprint tip tool 2 with respect to the end face of the optical waveguide component 7. As described above, the moving mechanism may be any mechanism that relatively moves the imprint tip tool 2 (i.e. mold 2A) with respect to the end face of the optical waveguide component 7.

In this embodiment, as described above, the controller 6 calculates the positional relationship between the center position of the core 7A and the center position of the mold 2A by using the center position of the taken image, that is, the center position of the camera 3, and on the basis of this positional relationship, the controller 6 controls the X-Y mover 5 so that the center position of the core 7A and the center position of the mold 2A coincide with each other. However, this is not to be construed restrictively. For example, the controller 6 may calculate the positional relationship between the center position of the core 7A and the center position of the mold 2A by using a reference position of the taken image, that is, a reference position of the camera 3, and on the basis of this positional relationship, the controller 6 may control the X-Y mover 5 so that the center position of the core 7A and the center position of the mold 2A coincide with each other. Alternatively, for example, on the basis of a position other than the center position of the core 7A within the image taken by the camera 3, the controller 6 may control the X-Y mover 5 so that the position other than the center position of the core 7A and a position other than the center position of the mold 2A coincide with each other. It suffices as long as the controller 6 controls the moving mechanism so that the position of the core 7A and the position of the mold 2A coincide with each other, on the basis of the position of the core 7A within the image taken by the camera 3 in this way.

Next, an optical component manufacturing method according to the embodiment is described.

In the embodiment, by using the imprint apparatus configured as described above, the mold 2A is pressed onto the optical film 10 positioned at the end face of the optical waveguide component 7 to form the lens 11 on the surface of the optical film 10, thereby manufacturing the optical component 14 having the lens 11 mounted on the end face of the optical waveguide component 7 (see, for example, FIG. 5C and FIG. 8).

First, as depicted in FIGS. 3 and 4, the optical film 10 is positioned at the end face of the optical waveguide component 7 including the core 7A and the cladding 7B. At this time, temporary fixing may be performed by bonding the optical film 10 to the end face of the optical waveguide component 7 with an optical adhesive, for example.

In the present case, as depicted in FIG. 3, the core 7A is positioned in the vicinity of the center of the optical waveguide component 7, and the end face of the core 7A is exposed in the vicinity of the center of the end face of the optical waveguide component 7.

The optical film 10 has light transmitting property. Accordingly, after the optical film 10 is positioned at the end face of the optical waveguide component 7 in this way, an image of the end face of the optical waveguide component 7 may be taken by the camera 3 as described later.

Moreover, the optical film 10 is a thermosetting resin film or photosetting resin film.

A thermosetting resin film is a film made of resin that may be formed by setting the film by application of heat. Examples of such a film include a thermosetting resin film and a thermoplastic resin film. For example, a polyimide resin film or the like may be used. For example, among general-purpose and engineering plastics or the like, one with high transparency is preferably used.

A photosetting resin film is a film made of resin that may be formed by setting the film by irradiation with light. For example, a film obtained by forming a compound having ultraviolet-curable resin added to an acrylic pressure sensitive adhesive into a film form, or a film having polyimide as base resin may be used. That is, an ultraviolet-curable resin film, an acrylic resin film, a polyimide resin film, or the like may be used. For example, a Poly(methyl methacrylate) (PMMA) film may be used.

As the optical film 10, it is preferable to use an optical film having a refractive index after setting of approximately 1.3 to approximately 1.5.

Next, as depicted in FIG. 1, the optical waveguide component 7 is set on the above-mentioned imprint apparatus so that the end face where the optical film 10 is positioned faces up. That is, the optical waveguide component 7 is placed on the table 1 of the above-mentioned imprint apparatus so that the end face where the optical film 10 is positioned faces up, and fixed in position with the chuck 9. As a result, rough positioning of the optical waveguide component 7 with respect to the component placement region of the table 1 is performed. In this case, the optical waveguide component 7 is misaligned by a maximum of approximately 50 μm with respect to the component placement region of the table 1.

Next, the camera 3 is moved by the X-Y mover 5 to a position where an image of the end face of the optical waveguide component 7 may be taken, that is, a position above the end face of the optical waveguide component 7. That is, in order to take an image of the end face of the optical waveguide component 7, the camera 3 is moved by the X-Y mover 5 so that the center position of the component placement region of the table 1 and the center position of the camera 3 coincide with each other. In this case, the center position of the end face of the optical waveguide component 7 placed on the component placement region and the center position of the camera 3 are misaligned by a maximum of approximately 50 μm.

Next, an image of the end face of the optical waveguide component 7 is taken by the camera 3. At this time, although the optical film 10 is positioned at the end face of the optical waveguide component 7, the optical film 10 has light transmitting property, and thus an image of the end face of the optical waveguide component 7 may be taken by the camera 3 through the optical film 10. Then, the image taken by the camera 3 is sent to the controller 6.

The embodiment is not limited to the above-mentioned configuration. The optical film 10 may not have light transmitting property. In this case, for example, the optical film 10 may be positioned at the end face of the optical waveguide component 7 after an image of the end face of the optical waveguide component 7 is taken. That is, the optical waveguide component 7 not having the optical film 10 positioned at its end face may be set on the imprint apparatus, and after taking an image of the end face of the optical waveguide component 7 by the camera 3, the optical film 10 may be positioned at the end face of the optical waveguide component 7.

Next, on the basis of the center position of the core 7A within the taken image, the center position of the core 7A and the center position of the mold 2A are aligned with each other.

That is, first, on the basis of the center position of the core 7A within the image taken by the camera 3, the controller 6 controls the X-Y mover 5 so that the center position of the core 7A and the center position of the mold 2A coincide with each other (see, for example, FIG. 5A).

At this time, first, the controller 6 captures the image taken by the camera 3, and determines the center position of the core 7A within the image through image processing. Then, the controller 6 calculates and stores the amount of misalignment (offset) of the center position of the core 7A with respect to the center position of the taken image. Next, the controller 6 calculates and stores the amount of misalignment of the mold 2A with respect to the core 7A, on the basis of the amount of misalignment of the center position of the core 7A with respect to the center position of the taken image, and the amount of misalignment of the center position of the mold 2A with respect to the center position of the camera 3. Then, the controller 6 controls the X-Y mover 5 on the basis of the amount of misalignment of the center position of the mold 2A with respect to the center position of the core 7A. That is, the controller 6 controls the X-Y mover 5 so that the center position (the X-coordinate and the Y-coordinate) of the core 7A, and the center position (the X-coordinate and the Y-coordinate) of the mold 2A coincide with each other. As a result, as depicted in FIG. 5A, it is possible to align the center position of the mold 2A with good accuracy (e.g. approximately 0.5 μm or less) with respect to the center position of the core 7A of the optical waveguide component 7.

Next, as depicted in FIGS. 5A to 5C, the mold 2A provided at the tip portion of the imprint tip tool 2 is pressed onto the optical film 10 to thereby form the lens 11 (microlens) on the surface of the optical film 10.

At this time, the controller 6 controls the elevator 4 to lower the imprint tip tool 2 by a predetermined distance, thereby pressing the mold 2A provided at the tip portion of the imprint tip tool 2 onto the optical film 10 positioned at the end face of the optical waveguide component 7. As a result, the optical film 10 is deformed, and the lens shape (concave lens shape in the present case) provided in the mold 2A is transferred, thereby forming the lens (convex lens in the present case) 11 on the surface of the optical film 10.

For example, in a case where the optical film 10 is a thermosetting resin film, the lens 11 may be formed on the surface of the optical film (thermosetting resin film) 10 by pressing the mold 2A provided at the tip portion of the imprint tip tool 2 onto the optical film (thermosetting resin film) 10, and setting the optical film (thermosetting resin film) 10 by heating. In this case, the imprint tip tool 2 is made of a material capable of transferring heat such as metal (e.g. electroformed Ni), the heater 12 (see FIG. 6) is provided at the basal portion of the imprint tip tool 2, and while pressing the mold 2A provided at the tip portion of the imprint tip tool 2 on the optical film (thermosetting resin film) 10, the optical film (thermosetting resin film) 10 may be set by heating the optical film (thermosetting resin film) 10 by the heater 12.

Next, in a case where the optical film 10 is a photosetting resin film, the lens 11 may be formed on the surface of the optical film (photosetting resin film) 10 by pressing the mold 2A provided at the tip portion of the imprint tip tool 2 onto the optical film (photosetting resin film) 10, and setting the optical film (photosetting resin film) 10 by irradiation with light. In this case, the imprint tip tool 2 is made of a material that transmits light such as glass (SiO₂), a light source that irradiates the optical film (photosetting resin film) 10 with light is provided, and while pressing the mold 2A provided at the tip portion of the imprint tip tool 2 onto the optical film (photosetting resin film) 10, the optical film (photosetting resin film) 10 may be set by irradiating the optical film (photosetting resin film) 10 with light from the light source.

The embodiment is not limited to the above-mentioned configuration. For example, the optical film (photosetting resin film) 10 may be set by irradiating the optical film (photosetting resin film) 10 with light from the end face of the optical waveguide component 7 opposite to the side where the optical film (photosetting resin film) 10 is positioned (see, for example, FIG. 7). For example, the light source 13 is provided on the back side of the table 1, and at least the component placement region of the table 1 is formed so as to be able to transmit light. Then, with the mold 2A provided at the tip portion of the imprint tip tool 2 being pressed on the optical film (photosetting resin film) 10, the optical film (photosetting resin film) 10 may be set by irradiating the optical film (photosetting resin film) 10 with light through the core 7A of the optical waveguide component 7 from the light source 13 provided on the back side of the table 1 (see, for example, FIG. 7). In this case, the imprint tip tool 2 including the mold 2A may not be made of a material that transmits light.

In a state in which the mold 2A provided at the tip portion of the imprint tip tool 2 is pressed on the optical film 10 in this way, that is, in a state in which the optical film 10 is deformed into a lens shape, by setting the optical film 10 by application of heat or light, the lens shape is transferred/formed, and the lens shape is retained so that the lens 11 is formed on the surface of the optical film 10. Then, as the optical film 10 sets with application of heat or light, the optical film 10 is stuck onto the end face of the optical waveguide component 7. In a case where, for example, temporary fixing is previously performed by bonding the optical film 10 with an optical adhesive when positioning the optical film 10, final fixing is performed at this point.

The portion of the optical film 10 other than the lens 11 may be left as it is, or may be removed. For example, the portion of the optical film 10 other than the lens 11 may be also left as it is by setting this portion with application of heat or light so as not to drop off. Alternatively, the portion of the optical film 10 other than the lens 11 may be made to remain unset, and removed by cleansing in a subsequent step.

Therefore, the optical component manufacturing method and the optical component manufacturing apparatus according to the embodiment has the advantage of allowing the lens 11 to be formed easily and inexpensively with good accuracy with respect to the position of the core 7A of the optical waveguide component 7. That is, rather than mounting a prefabricated lens on an optical waveguide component, the position of the core 7A of the optical waveguide component 7 is determined by image recognition, the mold 2A is aligned with the core 7A of the optical waveguide component 7, and the mold 2A is pressed onto the optical film 10 positioned at the end face of the optical waveguide component 7 to thereby form the lens 11 by embossing. Therefore, the lens 11 may be formed easily and inexpensively with good accuracy with respect to the position of the core 7A of the optical waveguide component 7. As a result, the positioning accuracy is relaxed, and positioning becomes easy, thereby achieving optical coupling between optical waveguide components in a compact and inexpensive manner.

For example, as depicted in FIG. 8, the following optical component 14 is considered. That is, the optical component 14 has the optical film 10 provided at the end face of the optical waveguide component 7 (e.g. SHG) whose core 7A has a size of approximately 4 μm in both length and width. The optical film 10 includes the lens (convex lens) 11 with a curvature radius of approximately 10 μm on its surface, and made of, for example, PMMA whose refractive index after setting is 1.49 and whose thickness after pressing is approximately 25 μm. In the optical component 14 mentioned above, as indicated by two-dot chain lines in FIG. 8, incident light may be condensed and made incident on the core 7A of the optical waveguide component 7 by the lens (convex lens) 11. In this case, the distance from the end face of the core 7A of the optical waveguide component 7 to the center of curvature radius of the lens (convex lens) 11 is approximately 18 μm. The optical component 14 is also referred to as an optical waveguide component or optical coupling component with a lens.

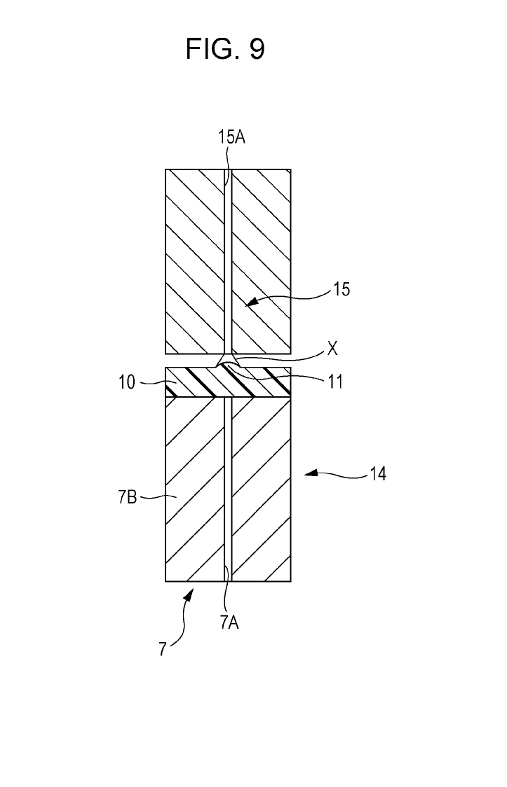

By using the optical component 14 including the above-mentioned configuration as an incidence-side component, as depicted in FIG. 9, the optical component (incidence-side component) 14 and an emission-side component 15 may be optically coupled via the lens 11. The emission-side component 15 is, for example, an optical waveguide component (e.g. LD) whose core has a size of approximately 2.5 μm in length and approximately 3.0 μm in width. In FIG. 9, symbol X denotes emitted light. Optical coupling is also referred to as optical jointing. Optical coupling via a lens is also referred to as lens optical jointing or microlens optical jointing.

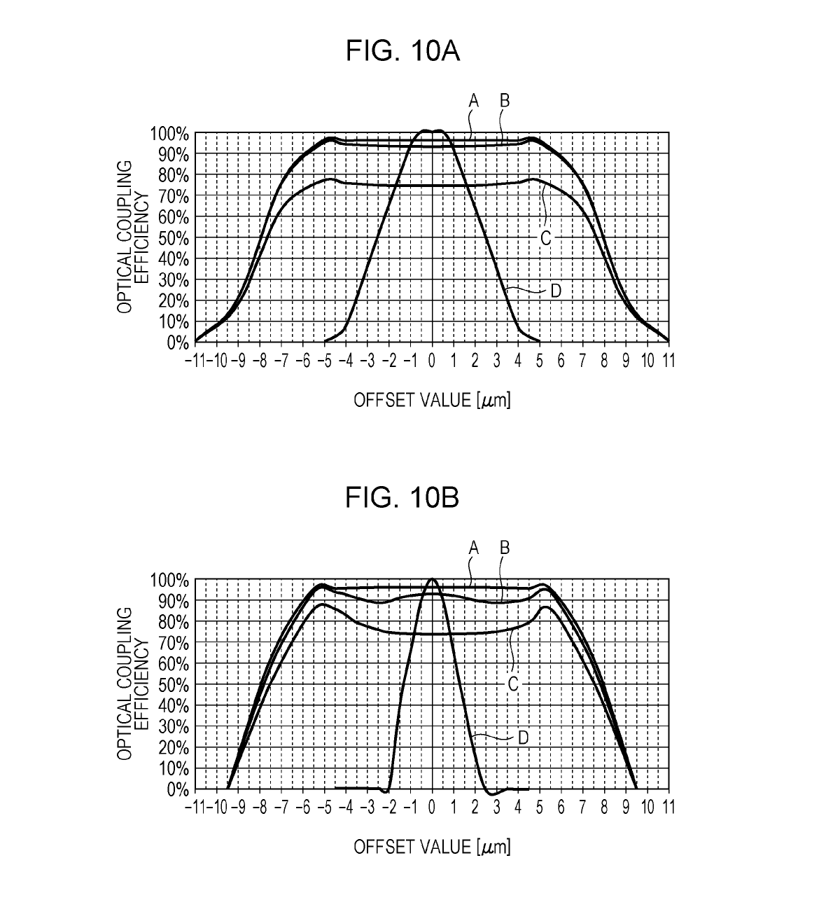

FIGS. 10A and 10B depict optical efficiency in the case of the optical coupling structure depicted in FIG. 9. That is, FIG. 10A depicts tolerance in the X-direction, that is, the relationship between offset value and optical coupling efficiency in a case were the optical component (incidence-side component) 14 and the emission-side optical component 15 are offset relative to each other in the X-direction. FIG. 10B depicts tolerance in the Y-direction, that is, the relationship between offset value and optical coupling efficiency in a case were the optical component (incidence-side component) 14 and the emission-side optical component 15 are offset relative to each other in the Y-direction. The X-direction represents the left-right direction in FIG. 9, and the Y-direction represents a direction perpendicular to the plane of FIG. 9. In the present case, the offset value in the Z-direction, which is the up-down direction in FIG. 9, is approximately 2 μm.

In FIGS. 10A and 10B, solid lines A to C indicate the optical coupling efficiencies when the radiation angles of light emitted from a core 15A of the emission-side component 15 are approximately 3 degrees, approximately 5 degrees, and approximately 7 degrees, respectively, in the case of the optical coupling structure depicted in FIG. 9.

For comparison, FIGS. 10A and 10B also depict the optical coupling efficiency when optical coupling is performed by butt jointing by using an incidence-side component 14X as an optical component that does not include the optical film 10 having the lens 11, in the case of the structure depicted in FIG. 9.

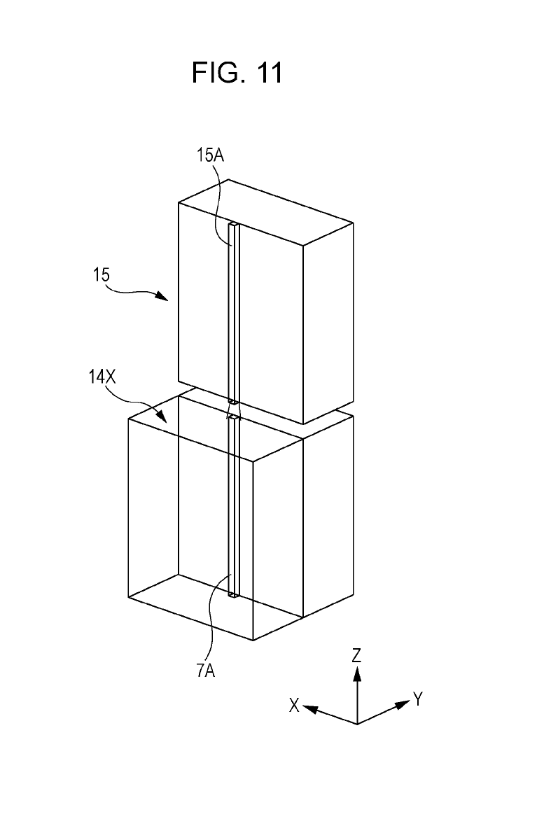

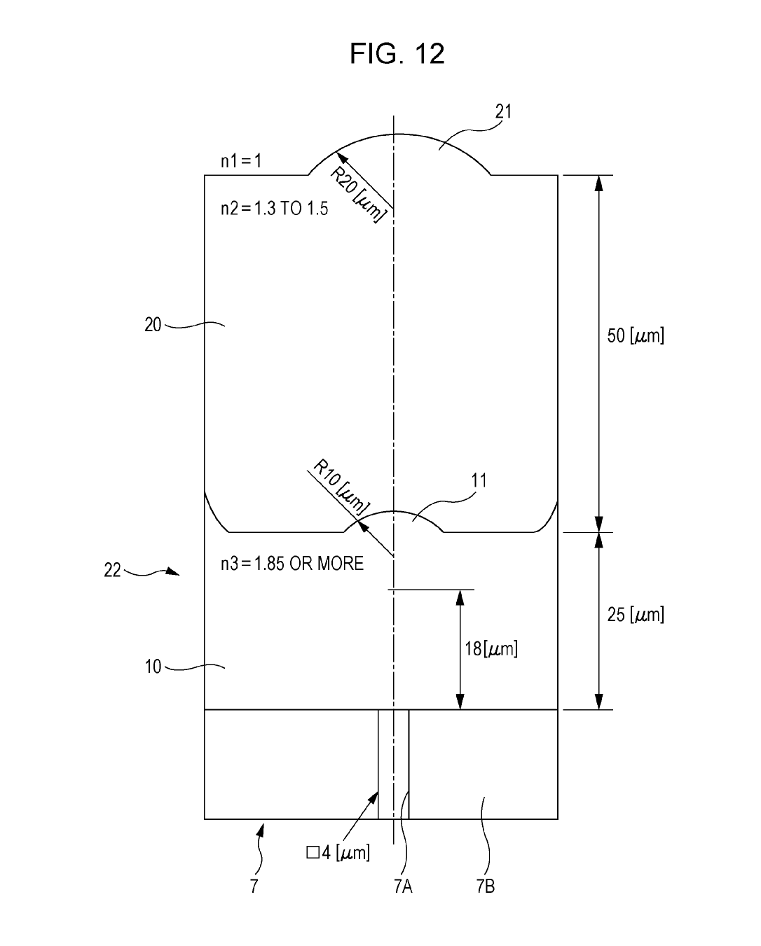

In FIGS. 10A and 10B, a solid line D indicates the optical coupling efficiency when the radiation angle of light emitted from the core 15A of the emission-side component 15 is approximately 5 degrees (or approximately 7 degrees) in a case where optical coupling is performed by butt jointing. In the present case, optical coupling efficiency is measured by positioning and optically coupling the incidence-side component 14X and the emission-side component 15 as depicted in FIG. 11, and the coordinate axes in this case are as depicted in FIG. 11.

As depicted in FIGS. 10A and 10B, in a case where the radiation angle of light emitted from the emission-side component 15 is set to approximately 10 degrees or less in the optical coupling structure depicted in FIG. 9, the optical coupling efficiency does not drop below a target value of approximately 70% until the point when the offset values in the X-direction and Y-direction become approximately ±6 to 6.5 μm. In contrast, in a case where optical coupling is performed by the butt jointing depicted in FIG. 11, the optical coupling efficiency drops below the target value of approximately 70% at the point when the offset values in the X-direction and Y-direction become approximately ±1.0 to 1.5 μm (approximately ±0.5 μm if manufacturing variability or the like is further taken into account). Since the optical coupling efficiency varies with the radiation angle of light emitted from the emission-side component 15, it is preferable to vary the curvature radius of the lens 11 or the refractive index of the optical film 10 forming the lens 11 in accordance with the radiation angle.

In this way, by performing optical coupling as depicted in FIG. 9 by using the optical component 14 depicted in FIG. 8 as an incidence-side component, the positioning accuracy between the optical component (incidence-side component) 14 and the emission-side component 15 may be relaxed, and positioning becomes easy, thereby achieving optical coupling between optical waveguide components in a compact and inexpensive manner. That is, in the case of performing optical coupling by butt jointing depicted in FIG. 11, to achieve high optical coupling efficiency, very little error is tolerated for the positioning between the core 7A of the optical component (incidence-side component) 14 and the core 15A of the emission-side component 15, and high positioning accuracy is to be attained. In contrast, by performing optical coupling as depicted in FIG. 9 by using the optical component 14 depicted in FIG. 8 as an incidence-side component, high optical coupling efficiency may be achieved with relaxed positioning accuracy. Positioning accuracy is also referred to as assembling accuracy, positioning tolerance, or assembling tolerance.

When considering commercialization (practical utilization), not only the positioning accuracy at the time of assembly is to be taken into account but also it is preferable that the completed optical component be able to absorb changes in relative position (e.g. on the order of approximately 1 μm to approximately 2 μm) due to temperature changes or changes over time that take place after assembly. However, this is difficult to achieve in the case of performing optical coupling by butt jointing depicted in FIG. 11. In contrast, this may be achieved by performing optical coupling as depicted in FIG. 9 by using the optical component 14 depicted in FIG. 8 as an incidence-side component.

While the above description is directed to the case where the optical component 14 depicted in FIG. 8, that is, the optical waveguide component 7 with the lens 11 is used as an incidence-side optical component, this is not to be construed restrictively. For example, the optical waveguide component 7 with the lens 11 may be used not only for the optical component (incidence-side component) 14 but also the emission-side component 15.

The embodiment is not limited to the configuration mentioned above. Various modifications are possible without departing from the scope of the embodiment.

For example, in the above-mentioned embodiment, the lens 11 is formed on the optical film 10 positioned at the end face of the optical waveguide component 7 to thereby manufacture the optical component 14 in which a single optical film 10 having the lens 11 is stuck on the end face of the optical waveguide component 7. However, this is not to be construed restrictively.

For example, as depicted in FIG. 12, an optical component 22 described below may be manufactured. That is, after forming the lens 11 on the optical film 10 positioned at the edge face of the optical waveguide component 7, another optical film 20 having a different refractive index is stacked, and another lens 21 having a different size is formed on the other optical film 20, thereby manufacturing the optical component 22 in which the two optical films 10 and 20 with the two lenses 11 and 21 are stuck on the end face of the optical waveguide component 7. In this case, the optical film 10 positioned at the end face of the optical waveguide component 7 has a refractive index after setting of approximately 1.85 or more, for example, and the other optical film 20 stacked on top of the optical film 10 has a refractive index after setting of approximately 1.3 to approximately 1.5, for example. For example, as the other optical film 20, an optical film made of PMMA whose refractive index after setting is approximately 1.49 and whose thickness after pressing is approximately 50 μm may be used. As the optical film 10, an optical film having a refractive index higher than that of the other optical film 20 is to be used. Accordingly, for example, an optical film made of a hybrid thin film or the like including a transparent oxide (ZnO) or the like whose refractive index after setting is approximately 1.85 or more and whose thickness after pressing is approximately 25 μm may be used. As the lens 11, as in the above-mentioned embodiment, a convex lens with a curvature radius of approximately 10 μm may be formed on the surface of the optical film 10. As the other lens 21, a convex lens with a curvature radius of approximately 20 μm may be formed on the surface of the other optical film 20. As in the above-mentioned embodiment, the optical waveguide component 7 to which the optical films 10 and 20 are stuck is an optical waveguide component (e.g. SHG) whose core 7A has a size of approximately 4 μm in both length and width.

In this way, the optical component 22 including a double lens structure at the end face of the optical waveguide component 7 may be manufactured by, after forming the lens 11 on the optical film 10 positioned at the end face of the optical waveguide component 7 as in the above-mentioned embodiment, positioning the other optical film 20 having a lower refractive index than the optical film 10 on top of the optical film 10, and pressing another mold different from the mold 2A according to the above embodiment onto the other optical film 20 to form the other lens 21 having a larger size than the lens 11 on the surface of the other optical film 20. In this case, the lens forming process by imprinting using the imprint apparatus according to the above-mentioned embodiment is performed twice.

As a result, the positioning accuracy when optically coupling two optical waveguide components may be further relaxed. That is, the positioning tolerance when optically coupling two optical waveguide components may be further increased.

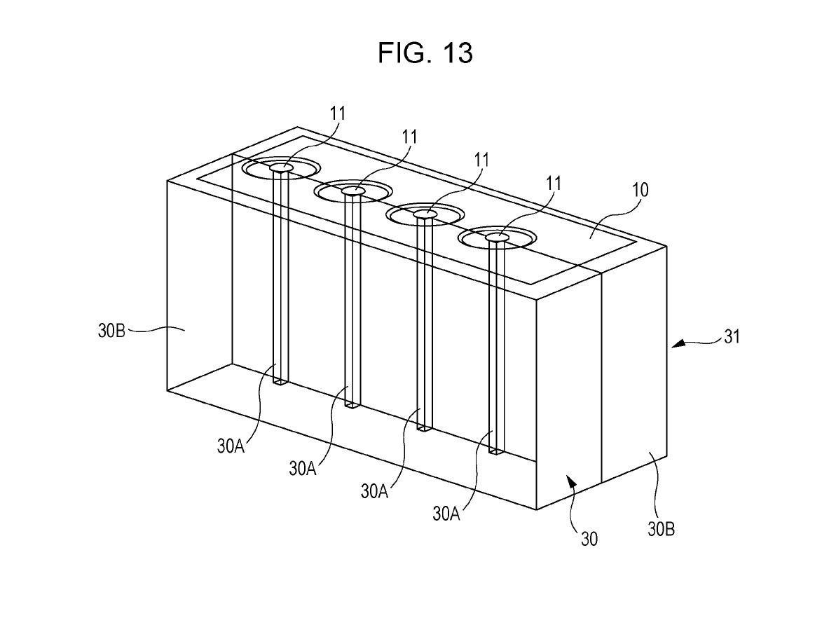

While the above-mentioned embodiment is directed to the case of the optical waveguide component 7 having a single optical waveguide, that is, the optical waveguide component 7 having a single core 7A, this is not to be construed restrictively. For example, the embodiment may be also applied to an optical connector having multiple optical waveguides (arrayed optical waveguides) or multiple optical fibers (arrayed optical fibers). For example, as depicted in FIG. 13, in the same manner as in the above-mentioned embodiment, multiple lenses 11 (microlenses) may be formed on the surface of the optical film 10, which is positioned at the end face (incidence end face) of an optical connector 30 including multiple cores 30A and claddings 30B, at positions corresponding to the respective cores 30A. In this case, an optical component 31 is manufactured, in which the optical film 10 including the multiple lenses 11 are stuck on the end face of the optical connector 30 that is an optical waveguide component having the multiple cores 30A. By applying the embodiment to the optical connector 30 in this way, in the connection between optical connectors for which finer positioning accuracy (tolerance) is to be provided, it is possible to achieve an optical connection structure that is tolerant of misalignment and does not depend on the relative position, pitch accuracy, relative angle, or the like. In particular, by providing the optical connection structure with the above-mentioned double lens structure (see FIG. 12), the positioning accuracy may be further relaxed.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A method for manufacturing an optical component, the method comprising:
taking an image of an end face of an optical waveguide component including a core and a cladding;
aligning a position of the core with a position of a mold, on a basis of the position of the core within the taken image; and
forming a lens on a surface of an optical film positioned at the end face of the optical waveguide component by pressing the mold onto the optical film.

2. The method for manufacturing an optical component according to claim 1, wherein:
the optical film has light transmitting property; and
the method for manufacturing an optical component further comprises taking the image of the end face of the optical waveguide component after positioning the optical film at the end face of the optical waveguide component.

3. The method for manufacturing an optical component according to claim 1, further comprising positioning the optical film at the end face of the optical waveguide component after taking the image of the end face of the optical waveguide component.

4. The method for manufacturing an optical component according to claim 1, wherein:
the optical film is a thermosetting resin film; and
the method for manufacturing an optical component further comprises forming the lens on a surface of the thermosetting resin film, by pressing the mold onto the thermosetting resin film and setting the thermosetting resin film by heating the thermosetting resin film.

5. The method for manufacturing an optical component according to claim 1, wherein:
the optical film is a photosetting resin film; and
the optical component manufacturing method further comprises forming the lens on a surface of the photosetting resin film, by pressing the mold onto the photosetting resin film and setting the photosetting resin film by irradiating the photosetting resin film with light.

6. The method for manufacturing an optical component according to claim 5, further comprising setting the photosetting resin film by irradiating the photosetting resin film with light from an end face of the optical waveguide component opposite to a side where the optical film is positioned.

7. The method for manufacturing an optical component according to claim 1, further comprising, after forming the lens, forming another lens having a larger size than the lens on a surface of another optical film positioned on top of the optical film and having a lower refractive index than the optical film, by pressing another mold different from the mold onto the other optical film.

8. An optical component manufacturing apparatus comprising:
a table on which to place an optical waveguide component including a core and a cladding;
an imaging unit to take an image of an end face of the optical waveguide component;
a mold that is pressed onto an optical film positioned at the end face of the optical waveguide component to form a lens on a surface of the optical film;
a moving mechanism to move the mold with respect to the end face of the optical waveguide component; and
a controller to control the moving mechanism on a basis of a position of the core within the image taken by the imaging unit, so that the position of the core and a position of the mold coincide with each other.

9. The optical component manufacturing apparatus according to claim 8, wherein:
the optical film is a thermosetting resin film; and
the optical component manufacturing apparatus further comprises a heater that heats the thermosetting resin film.

10. The optical component manufacturing apparatus according to claim 8, wherein:
the optical film is a photosetting resin film; and
the optical component manufacturing apparatus further comprises a light source that irradiates the photosetting resin film with light.

11. The optical component manufacturing apparatus according to claim 10, wherein the light source is provided on a back side of the table.
